(19) United States
(12) Patent Application Publication
(10) Pub. No.: US 2025/0145801 A1
(43) Pub. Date: May 8, 2025

(54) METHOD FOR PREPARING GRAPHENE-MODIFIED NATURAL RUBBER WITH AN INTERFACIAL INTERACTION BASED ON A FREE RADICAL ANNIHILATION REACTION

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Rongyao TAO, Taiyuan (CN); Guizhe ZHAO, Taiyuan (CN)

(21) Appl. No.: 19/013,796

(22) Filed: Jan. 8, 2025

Related U.S. Application Data
(63) Continuation of application No. PCT/CN2023/139948, filed on Dec. 19, 2023.

(30) Foreign Application Priority Data
Dec. 6, 2023 (CN) 202311659208.X

(51) Int. Cl. C08K 9/00; C08J 3/215; C08L 7/02

(52) U.S. Cl. CPC C08K 9/00; C08J 3/215; C08L 7/02; C08J 2307/02

(57) ABSTRACT

A method for preparing a graphene-modified natural rubber (NR) with an interfacial interaction based on a free radical annihilation reaction is provided. In the process of reducing graphene oxide (GO), a free radical scavenger is loaded on a surface of reduced graphene oxide (rGO). An rGO-modified NR composite is prepared through aqueous synergistic aggregating precipitation process and mechanical blending. The free radical scavenger loaded on the rGO particles are capable of annihilating macromolecular free radicals generated by NR macromolecules due to an action of heat and/or force during the mixing and milling processes, an enhancement effect of the free radical annihilation reaction on an interfacial interaction between graphene and NR is great, so as to obtain a graphene-modified NR composite with improved strength and toughness.

### CROSS-REFERENCE TO RELATED APPLICATIONS

This application is a continuation of International Patent Application No. PCT/CN2023/139948, filed on Dec. 19, 2023, which claims the benefit of priority from Chinese Patent Application No. 202311659208.X, filed on Dec. 6, 2023. The content of the aforementioned application, including any intervening amendments made thereto, is incorporated herein by reference in its entirety.

### TECHNICAL FIELD

This application relates to graphene and functional rubber composites thereof, and more particularly to a method for preparing a graphene-modified natural rubber with an interfacial interaction based on a free radical annihilation reaction.

### BACKGROUND

With the rapid development of modern three-dimensional transportation, rubber composites play an increasingly significant role in the transportation system. Natural rubber (NR) has been widely used in national defense and livelihood fields, such as tires, wires, cables, etc. by virtue of its excellent mechanical performance, tear resistance, and elasticity. However, its service life and operational stability still need to be further optimized.

In addition, NR itself has low strength, and only reinforced NR can be used in various products. Adding nanofillers is one of the most common reinforcement methods to achieve excellent strength and application flexibility. Therefore, in order to improve the properties of NR, nanoparticles, such as ceramic particles, nanodiamonds, carbon nanotubes, and graphene (GE), have become ideal fillers for reinforcing rubber matrixes due to their small size and large specific surface area. GE and its derivatives thereof are considered as the most ideal fillers for NR composites, and are often used for improving mechanical, electrical, thermal, and chemical performances of the matrixes. As an important GE derivative, graphene oxide (GO) has a remarkable dispersibility in the matrix due to the abundant presence of oxygen-containing groups such as hydroxyl groups, epoxy groups, carboxyl groups, and carbonyl groups. Therefore, GO has been extensively applied to the reinforcement of polymer composites.

The properties of nanofiller reinforced rubber composites are greatly dependent on dispersibility of the filler and interfacial interaction between the filler and the rubber matrix. The interfacial interaction between the nanofiller and the polymer matrix will significantly affect the rubber properties and the particle dispersion. In the case of a strong interfacial interaction, the nanoparticles will be uniformly dispersed, and the performance of the composites will be enhanced significantly. Therefore, the construction of a strong interfacial interaction between the matrix and the filler is the key to the successful application of polymer composites.

Although the filler modification method greatly improves the mechanical properties of rubber composites, more than a dozen or even more than 100 parts of fillers are commonly required in practical applications, which poses great challenges to the dispersion and interfacial regulation. In addition, the introduction of a large number of fillers will weaken the elasticity of rubber, thereby increasing the energy consumption during the processing. Therefore, how to develop a novel and effective method to prepare high-strength and high-toughness rubber composites is still a great challenge in the field of development and application of rubber composites.

Excellent mechanical properties can make the product less prone to wear and breakage, thus reducing the replacement frequency of NR products to reduce production costs. Mechanical performances can directly reveal the construction of the rubber crosslinking network and the dispersion of fillers. Enhancing the interfacial interaction between the filler and the matrix can increase the bound rubber content, thereby increasing the crosslinking density. In addition, during the long-term use, free radicals will be generated in the rubber under the action of heat or force, which will accelerate the aging, resulting in the performance degradation. Improving the aging resistance can extend the service life of rubber. Therefore, various free radical adsorbents have been developed and applied to extend the service life of rubber and improve the quality stability of rubber products. Free radical scavengers can react with free radicals in rubber, thereby stabilizing the chemical structure of rubber and delaying its aging. Therefore, loading the free radical scavenger on the surface of GO while GO is reduced can not only prevent the aging caused by free radicals, but also enhance the interfacial interaction between the filler and the rubber, thereby effectively improving the strength, toughness, and aging resistance of rubber composites.

### SUMMARY

In order to improve the strength, toughness, and aging resistance of natural rubber (NR) to extend the service life of rubber products and expand the application fields, the present disclosure provides a reinforced and toughened graphene-modified NR, and a preparation method thereof with an interfacial interaction based on a free radical annihilation reaction.

Technical solutions of the present disclosure are described as follows.

In the preparation of a reinforced and toughened graphene-modified NR with a strong interfacial interaction based on a free radical annihilation reaction, firstly, a free radical scavenger is loaded on a surface of reduced graphene oxide (rGO) in the process of reducing graphene oxide (GO); and then an rGO-modified NR composite is prepared by means of aqueous phase synergistic aggregating precipitation process and mechanical blending. During the mechanical blending process, the free radical scavenger loaded on the surface of the rGO can annihilate the free radicals generated from the rubber macromolecules under the exposure to heat and/or force, which will significantly enhance the interfacial interaction between the two phases (superior to the hydrogen bonding). In this way, the bound rubber content of NR can be increased, and the crosslinking density of the rGO-modified NR composite is increased, and the crosslinking network of the rGO-modified NR composite is improved, so as to arrive at the graphene-modified NR composite with improved strength and toughness.

This application provides a method for preparing a graphene-modified NR with an interfacial interaction based on a free radical annihilation reaction, comprising:
(1) dissolving a free radical scavenger in water to obtain a solution; and adding a graphene oxide aqueous dispersion with a preset concentration to the solution followed by reaction to obtain a free radical scavenger-loaded reduced graphene oxide (rGO) aqueous dispersion;
(2) adding deionized water to a natural rubber latex to obtain a latex emulsion, and mixing the free radical scavenger-loaded rGO aqueous dispersion with the latex emulsion under stirring to obtain a mixed emulsion, wherein rGO particles loaded with the free radical scavenger are bonded with rubber particles in the mixed emulsion to form bound particles under an action of an electrostatic attraction between rGO particles and negative ions from a protein-phospholipid membrane on a surface of the rubber particles;
adding a flocculant to the mixed emulsion to obtain a crude rubber, wherein flocculation occurs due to a reduction of repulsion between negative charges of the rubber particles in the mixed emulsion that keeps the mixed emulsion stable, and the rubber particles in the mixed emulsion whose protection layers are damaged and the rGO particles further undergo mutual adsorption by means of x-x interaction, such that the bound particles and the rubber particles in the mixed emulsion are orderly aggregated and co-precipitated from an aqueous phase to obtain the crude rubber; and
subjecting the crude rubber to water washing and drying to obtain a free radical scavenger-loaded rGO-modified NR masterbatch; and
(3) sequentially adding a rubber additive and a reinforcing filler to the free radical scavenger-loaded rGO-modified NR masterbatch during a mixing process in an internal mixer to obtain a rubber mixture; and
cooling the rubber mixture to room temperature, and subjecting the rubber mixture to a milling process in an open two-roll mill, mixing with a vulcanizing agent and mill run until there are no bubbles in the rubber mixture; and allowing the rubber mixture to stand for a period of time, and placing the rubber mixture in a mold followed by vulcanization to obtain the graphene-modified NR composite; wherein the free radical scavenger loaded on the rGO particles are capable of annihilating macromolecular free radicals generated by NR macromolecules due to an action of heat and/or force during the mixing and milling processes, an enhancement effect of the free radical annihilation reaction on an interfacial interaction between graphene and NR is obtained, thereby increasing a bound rubber content of natural rubber, increasing a crosslinking density of graphene-modified NR composite, and improving a crosslinking network of graphene-modified NR composite.

In some embodiments, in step (1), the free radical scavenger is selected from the group consisting of ascorbic acid, citric acid, sodium alginate, acrylic acid, sodium lignosulfonate, and a combination thereof; the reaction is performed at 60-120° C. for 2-6 h; and a mass ratio of the free radical scavenger to GO is 0.5-2:1.

In some embodiments, in step (2), the deionized water is added to the natural rubber latex such that a concentration of the latex emulsion is 10-40 wt. %; a concentration of the rGO particles in the free radical scavenger-loaded rGO aqueous dispersion is 0.5-5 mg/mL; and the flocculant is selected from the group consisting of a calcium chloride solution, a sodium chloride solution, a potassium chloride solution, a sodium sulfate solution, a hydrochloric acid solution, a formic acid solution and a combination thereof.

In some embodiments, in step (3), a weight ratio of the free radical scavenger-loaded rGO-modified NR masterbatch to the reinforcing filler to the rubber additive is 100:30-90:10-20.

In some embodiments, in step (3), the rubber additive comprises an anti-aging agent, an antioxidant, an activator, a softener, and a vulcanization accelerator; and a weight ratio of the anti-aging agent to the antioxidant to the activator to the softener to the vulcanization accelerator to the vulcanizing agent is 2:2:5:2:2:2.

In some embodiments, the anti-aging agent is selected from the group consisting of 2,6-di-tert-butyl-4-methylphenol, 2,2,4-trimethyl-1,2-dihydroquinoline polymer, and 2-mercaptobenzimidazole; the antioxidant is selected from the group consisting of N-(1-methylisopentyl)-N′-phenyl-p-phenylenediamine, p-phenylaniline, and dilauryl thiodipropionate; the activator is selected from the group consisting of zinc gluconate, zinc oxide, and magnesium oxide; the softener is selected from the group consisting of stearic acid, dibutyl titanate, and dioctyl adipate; the reinforcing filler is selected from the group consisting of carbon black, silicon dioxide, and clay; the vulcanization accelerator is selected from the group consisting of N-tert-butyl-2-benzothiazolesulfenamide, N-cyclohexyl-2-benzothiazolesulfenamide, and N-(oxydiethylene)-2-benzothiazole sulfenamide; and the vulcanizing agent is sulfur or sulfur monochloride.

In some embodiments, in step (3), the mixing in the internal mixer is performed at 105-120° C. for 9-20 min; and the milling in the open two-roll mill is performed at 50-70° C. for 8-12 min.

In some embodiments, in step (3), the rubber mixture is allowed to stand for 18-36 h; and the vulcanization is performed at 135-170° C. and 10-30 MPa for 3-25 min.

Compared to the prior art, the present disclosure has the following beneficial effects.

(1) In the preparation method proposed herein, a simplified process suitable for industrial production is adopted to load a free radical scavenger on the surface of reduced graphene oxide (rGO) sheets, and during the subsequent processing steps, the loaded free radical scavenger can undergo an annihilation reaction with free radicals generated from the rubber macromolecules due to the presence of force and/or oxygen, which can enhance the interfacial interaction between the rubber matrix and rGO to improve the bound rubber content of NR, so that the crosslink density of the vulcanized NR is improved, and the crosslinking network is more complete, thereby arriving at the reinforced and toughened graphene-modified NR composite.

(2) By means of the annihilation reaction between the free radical scavenger loaded on the surface of the rGO and the free radicals generated when NR macromolecules are subjected to heat and/or force, the properties of NR are stabilized and the aging reaction is prevented; moreover, the problem that the antioxidant is prone to migration and volatilization can also be solved, thereby improving the aging resistance of the product.

(3) The preparation method of the present disclosure is simple and environmentally friendly, without any harsh requirements. The apparatuses involved in the preparation method are all conventional in the art, and thus the preparation provided herein is suitable for the industrial production. Therefore, this application is of great significance for promoting the application of graphene in the field of high-performance rubber.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated into and constitute a part of this specification, are intended to illustrate the embodiments of the disclosure, and are used for explaining the principles of the disclosure in conjunction with the specification.

In order to illustrate the technical solutions in the embodiments of the present disclosure or in the prior art more clearly, the drawings needed in the description of embodiments or the prior art will be briefly introduced below. Obviously, for those of ordinary skill in the art, other drawings can be obtained based on these drawings without exerting creative efforts.

FIG. 1 shows differential scanning calorimetry (DSC) curves of reduced graphene oxide (rGO)-modified natural rubber (NR) composites in Examples 1-3 of the present disclosure and Comparative Example 1;

FIG. 2a shows optical photographs of solutions of rGOs in Examples 1-3 of the present disclosure and Comparative Example 1 in 2,2-diphenyl-1-picrylhydrazyl (DPPH); FIG. 2b shows ultraviolet (UV)-vis spectra of the solutions of rGOs in Examples 1-3 of the present disclosure and Comparative Example 1 in DPPH; and FIG. 2c shows the linear relationship between free radical scavenging rate and amount of the free radical scavenger-loaded reduced graphene oxide in Example 2;

FIG. 3 shows the bound rubber content of the rGO-modified NR composites in Examples 1-3 of the present disclosure and Comparative Example 1;

FIG. 4 shows the crosslinking density of the rGO-modified NR composites in Examples 1-3 of the present disclosure and Comparative Example 1; and

FIG. 5 shows the preparation mechanism of the ascorbic acid free radical scavenger-loaded reduced graphene oxide in Examples 1-3.

### DETAILED DESCRIPTION OF EMBODIMENTS

In order to make those skilled in the art understand the above objects, features and beneficial effects of the present disclosure more clearly, the technical solutions of the present disclosure will be further described below. It should be noted that as long as there is no contradiction, the embodiments of the present disclosure and the features therein can be combined with each other.

Many specific details are described below to facilitate the understanding of the present disclosure, but the present disclosure can also be implemented in other ways different from those described herein. Obviously, described herein are merely some embodiments of the present disclosure, rather than all embodiments.

Provided herein is a method for preparing a reinforced and toughened graphene-modified natural rubber (NR) with an interfacial interaction based on a free radical annihilation reaction. Firstly, a free radical scavenger is loaded on a surface of reduced graphene oxide (rGO) in the process of reducing graphene oxide (GO); and then an rGO-modified NR composite is prepared by means of aqueous phase synergistic aggregating precipitation process and mechanical blending. During the mechanical blending process, the free radical scavenger loaded on the surface of the rGO can annihilate the free radicals generated from the rubber macromolecules under the exposure to heat and/or force, which will significantly enhance the interfacial interaction between the two phases (superior to the hydrogen bonding). In this way, the bound rubber content of NR can be increased, and the crosslinking density of the rGO-modified NR composite is increased, and the crosslinking network of the rGO-modified NR composite is improved, so as to arrive at the graphene-modified NR composite with improved strength and toughness.

The method includes the following steps.

Step (1) A free radical scavenger is dissolved in water to obtain a solution. A graphene oxide aqueous dispersion with a preset concentration is added to the solution followed by reaction to obtain a free radical scavenger-loaded reduced graphene oxide (rGO) aqueous dispersion.

Step (2) Deionized water is added to a natural rubber latex to obtain a latex emulsion. The free radical scavenger-loaded rGO aqueous dispersion is mixed with the latex emulsion under stirring to obtain a mixed emulsion. rGO particles loaded with the free radical scavenger are bonded with rubber particles in the mixed emulsion to form bound particles under an action of an electrostatic attraction between rGO particles and negative ions from a protein-phospholipid membrane on a surface of the rubber particles. The mixed emulsion is added with a flocculant to obtain a crude rubber. In this case, flocculation occurs due to a reduction of repulsion between negative charges of the rubber particles in the mixed emulsion that keeps the mixed emulsion stable, and the rubber particles in the mixed emulsion whose protection layers are damaged and the rGO particles further undergo mutual adsorption by means of x-x interaction, such that the bound particles and the rubber particles in the mixed emulsion are orderly aggregated and co-precipitated from an aqueous phase to obtain the crude rubber. The raw rubber is washed with water and dried to obtain a free radical scavenger-loaded rGO-modified NR masterbatch.

Step (3) A rubber additive and a reinforcing filler are sequentially added to the free radical scavenger-loaded rGO-modified NR masterbatch during a mixing process in an internal mixer to obtain a rubber mixture. The rubber mixture is cooled to room temperature and transferred to an open two-roll mill for a milling process, mixed with a vulcanizing agent and mill run until there are no bubbles in the rubber mixture. The rubber mixture is allowed to stand for a period of time, placed in a mold and vulcanized to obtain the graphene-modified NR composite; wherein the free radical scavenger loaded on the rGO particles are capable of annihilating macromolecular free radicals generated by NR macromolecules due to an action of heat and/or force during the mixing and milling processes, an enhancement effect of the free radical annihilation reaction on an interfacial interaction between graphene and NR is obtained, thereby increasing a bound rubber content of natural rubber, increasing a crosslinking density of graphene-modified NR composite, and improving a crosslinking network of graphene-modified NR composite. In an embodiment, in step (1), the free radical scavenger is selected from the group consisting of ascorbic acid, citric acid, sodium alginate, acrylic acid, sodium lignosulfonate, and a combination thereof; the reaction is performed at 60-120° C. for 2-6 h; and a mass ratio of the free radical scavenger to GO is 0.5-2:1.

In an embodiment, in step (2), the deionized water is added to the natural rubber latex such that a concentration of the latex emulsion is 10-40 wt. %; a concentration of the rGO particles in the free radical scavenger-loaded rGO aqueous dispersion is 0.5-5 mg/mL; and the flocculant is selected from the group consisting of a calcium chloride solution, a sodium chloride solution, a potassium chloride solution, a sodium sulfate solution, a hydrochloric acid solution, a formic acid solution, and a combination thereof.

In an embodiment, in step (3), a weight ratio of the free radical scavenger-loaded rGO-modified NR masterbatch to the reinforcing filler to the rubber additive is 100:30-90:10-20.

In an embodiment, in step (3), the rubber additive includes an anti-aging agent, an antioxidant, an activator, a softener, and a vulcanization accelerator; and a weight ratio of the anti-aging agent to the antioxidant to the activator to the softener to the vulcanization accelerator to the vulcanizing agent is 2:2:5:2:2:2.

In an embodiment, in step (3), the anti-aging agent is selected from the group consisting of 2,6-di-tert-butyl-4-methylphenol, 2,2,4-trimethyl-1,2-dihydroquinoline polymer, and 2-mercaptobenzimidazole; the antioxidant is selected from the group consisting of N-(1-methylisopentyl)-N′-phenyl-p-phenylenediamine, p-phenylaniline, and dilauryl thiodipropionate; the activator is selected from the group consisting of zinc gluconate, zinc oxide, and magnesium oxide; the softener is selected from the group consisting of stearic acid, dibutyl titanate, and dioctyl adipate; the reinforcing filler is selected from the group consisting of carbon black, silicon dioxide, and clay; the vulcanization accelerator is selected from the group consisting of N-tert-butyl-2-benzothiazolesulfenamide, N-cyclohexyl-2-benzothiazolesulfenamide, and N-(oxydiethylene)-2-benzothiazole sulfenamide; and the vulcanizing agent is sulfur or sulfur monochloride.

In an embodiment, in step (3), the mixing in the internal mixer is performed at 105-120° C. for 9-20 min; and the milling in the open two-roll mill is performed at 50-70° C. for 8-12 min.

In an embodiment, in step (3), the rubber mixture is allowed to stand for 18-36 h; and the vulcanization is performed at 135-170° C. and 10-30 MPa for 3-25 min.

The specific examples of the present disclosure will be described in detail below.

### Example 1

Provided herein was a method for preparing a reinforced and toughened graphene-modified NR based on interfacial interaction of a free radical annihilation reaction.

Step (1) 1 g of ascorbic acid (i.e., the free radical scavenger) was added to water, and stirred for 10 min for complete dissolution. A GO aqueous dispersion was added to the ascorbic acid solution such that a final concentration of GO particles was 2.5 mg/mL, where a mass ratio of ascorbic acid to GO was 0.5:1. The reaction system was reacted under stirring at 95° C. for 3 h to obtain an aqueous dispersion of rGO with the free radical scavenger loaded on the surface.

Step (2) Deionized water was added to a natural rubber latex and uniformly stirred to obtain a latex emulsion with a concentration of 20 wt. %. The aqueous dispersion of the free radical scavenger-loaded rGO was mixed with the latex emulsion under stirring to obtain a uniform mixed emulsion. The mixed emulsion was added with a 10 wt. % CaCl₂) solution (i.e., the flocculant), such that the rGO particles and rubber particles were orderly aggregated in the aqueous phase and synergistically precipitated to obtain a crude rubber. The crude rubber was washed with water, and dried to a constant weight in an oven at 50° C., so as to obtain an NR masterbatch modified by the free radical scavenger-loaded rGO, where a content of the rGO particles in the free radical scavenger-loaded rGO was 0.5 wt. %.

Step (3) 100 g of the NR masterbatch prepared in step (2) was subjected to internal mixing in an internal mixer at 110° C. and 40 rpm for 4 min, added with 2 g of N-(oxydiethylene)-2-benzothiazole sulfenamide as a vulcanization accelerator, 2 g of N-(1-methylisopentyl)-N′-phenyl-p-phenylenediamine as an antioxidant, and 2 g of 2,2,4-trimethyl-1,2-dihydroquinoline polymer as an anti-aging agent, mixed for 4 min, added with 5 g of zinc oxide as an activator and 2 g of stearic acid as a softener, mixed for 4 min, added with 60 g of carbon black as a reinforcing filler, and mixed for 4 min to obtain a rubber mixture. The rubber mixture was discharged, cooled to room temperature, and transferred to an open mill for milling at 60° C. After the rubber mixture was evenly dispersed, the rubber mixture was mixed with 2 g of sulfur and subjected to mill run until there were no bubbles in the rubber mixture. A total milling time was 10 min. The rubber mixture was allowed to stand for 24 h, placed in a mold and vulcanized at 150° C. and 15 MPa for a certain time (t_{c}90) (the time to reach 90% vulcanization was 5 min), so as to obtain the graphene-modified NR with improved strength and toughness, where the t_{c}90 was measured by a Rubber Process Analyzer (RPA).

### Example 2

The preparation method provided herein was basically the same as that in Example 1, except that in step (1), 2 g of the free radical scavenger ascorbic acid was added, and a mass ratio of ascorbic acid to GO was 1:1.

### Example 3

The preparation method provided herein was basically the same as that in Example 1, except that in step (1), 3 g of the free radical scavenger ascorbic acid was added, and a mass ratio of ascorbic acid to GO was 1.5:1.

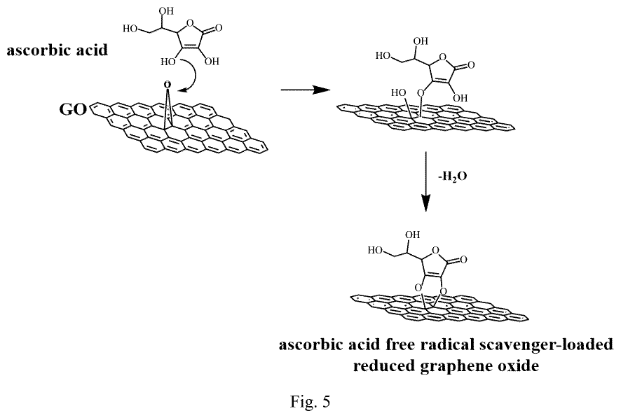

The preparation mechanisms of the ascorbic acid free radical scavenger-loaded reduced graphene oxide samples in Examples 1-3 were schematically shown in FIG. 5.

### Comparative Example 1

Provided herein was a method for preparing a GO-modified NR composite.

Step (1) GO was dispersed in deionized water to obtain a GO dispersion with a concentration of 2.5 mg/mL.

Step (2) This step was basically the same as the step (2) of Example 1, except that the aqueous dispersion of the rGO with the free radical scavenger loaded on the surface was replaced with the GO dispersion.

Step (3) This step was the same as the step (3) of Example 1.

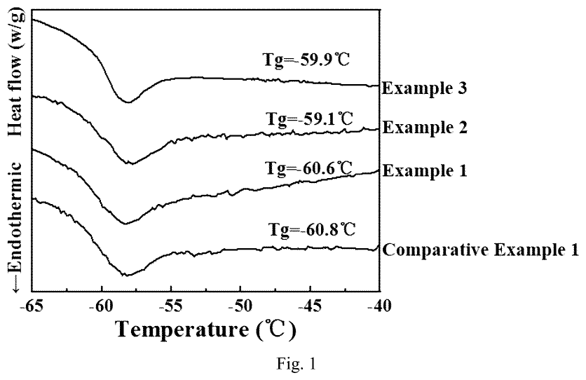

FIG. 1 showed differential scanning calorimetry (DSC) curves of NR composites prepared in Examples 1-3 and Comparative Example 1. The DSC test can determine the interaction between the matrix (i.e., the NR) and the filler (i.e., the rGO), because the presence of the filler usually causes a change in the glass transition temperature of the rubber. Compared with Comparative Example 1, the rubber composites prepared in Examples 1-3 had increased glass transition temperatures. This was because the interaction between the filler and NR macromolecular chains was enhanced, and the increase in the crosslinking network density restricted the movement of rubber chain segments.

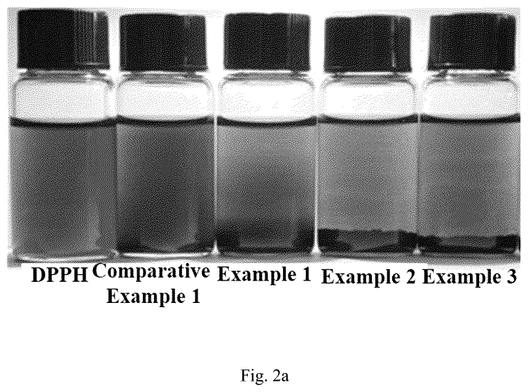

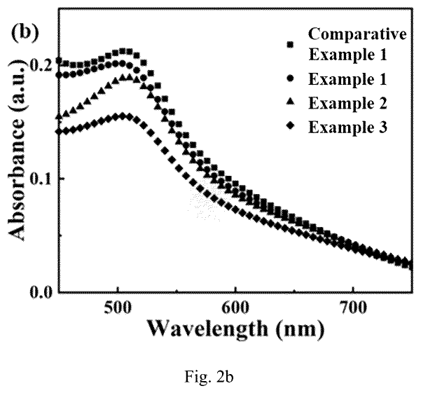

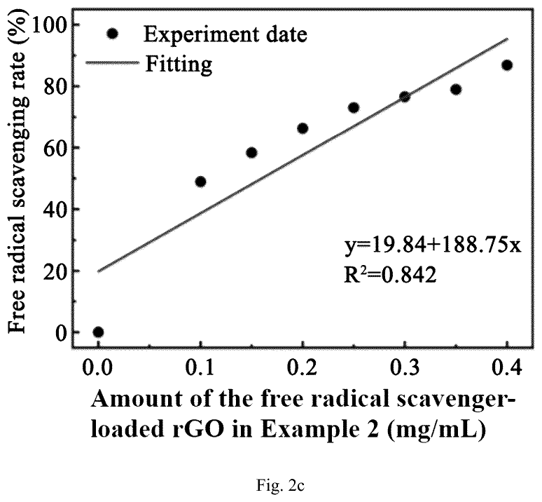

2,2-diphenyl-1-picrylhydrazyl (DPPH) is a stable free radical at ambient temperature. Due to its special color change before and after deactivation, DPPH is often selected as an indicator of the free radical annihilation reaction. As shown in FIG. 2a, when the DPPH solution was added with the GO that was to be added to the NR in Comparative Example 1, no change in color was observed, indicating that the GO was not capable of adsorbing free radicals. When the DPPH solution was added with the rGOs with the free radical scavenger loaded on the surface that was to be added to the NR in Examples 1-3, it was observed that the color of the DPPH solutions became significantly lighter. Moreover, during the generation of the rGO, as the addition amount of ascorbic acid (i.e., the free radical scavenger) was increased, the color of the DPPH solutions became lighter and lighter, from the initial dark purple to light purple and finally to light brown, indicating that the free radicals in the DPPH solution were completely annihilated by the system. Therefore, it can be concluded that the rGO with the highest addition amount of ascorbic acid had the greatest adsorption capacity for free radicals.

As shown in the ultraviolet (UV)-vis spectra of FIG. 2b, the absorption peak of the DPPH solution appeared at 532 nm-1, which originated from the delocalization of unpaired electrons in its aromatic molecules. The intensity of this peak tended to weaken with the increase of the addition amount of the ascorbic acid during the reaction process, indicating that the amount of adsorbed free radicals was increased. This further confirmed that rGO reduced with ascorbic acid is capable of adsorbing free radicals in NR. It is well known that during the processing, rubber macromolecules are activated by heat and/or force, which triggers chain breakage, such that macromolecular free radicals are generated. rGO can adsorb free radicals generated from rubber by means of loading ascorbic acid to bond with the rubber, thereby generating an interfacial interaction superior to hydrogen bonding (Existing in the GO-modified NR composite). Half maximal effective concentration (EC₅₀) is an important parameter for evaluating the ability to scavenge free radicals. The smaller the EC₅₀, the stronger the free radical scavenging ability. If the EC₅₀ of a test substance is less than 10 mg/mL, it indicates that the substance has free radical scavenging ability. The EC₅₀ of free radical scavenger-loaded reduced graphene oxide in Example 2 obtained from the linear fitting equation in FIG. 2c is 0.16 mg/mL, indicating its strong free radical scavenging ability.

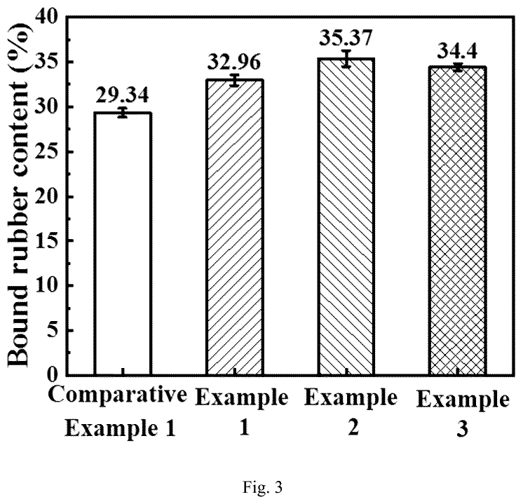

The formation of the crosslinking network structure depends greatly on the bound rubber content, which depends on the interaction between the matrix and the filler in the rubber composite. FIG. 3 showed bound rubber content of the rGO-modified NR composites prepared in Examples 1-3 and Comparative Example 1. Compared with Comparative Example 1, the bound rubber contents of the composites prepared in Examples 1-3 were significantly improved. Moreover, as the content of the free radical scavenger increased, the bound rubber content was increased, owing to the interfacial interaction between the filler and the rubber was enhanced. Because the bound rubber content depends on the interaction between matrix and filler in compound rubber.

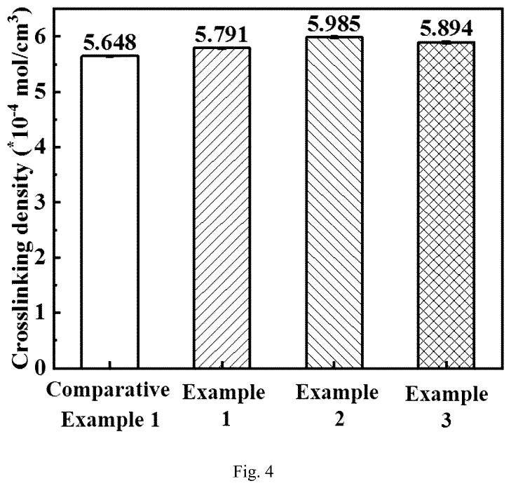

FIG. 4 showed crosslinking density of the rGO-modified NR composites prepared in Examples 1-3 and Comparative Example 1. Compared with Comparative Example 1, the crosslinking density of the composites prepared in Examples 1-3 was significantly improved, indicating the interfacial interaction based on free radical annihilation reaction was stronger than that based on hydrogen bonding (Existing in the GO-modified NR composite). Moreover, as the content of the free radical scavenger increased, the crosslinking density of the composites was increased, and the crosslinking network became more complete, owing to the interfacial interaction between the filler and the rubber was enhanced.

Ascorbic acid has strong reducibility, and both cyclic and chain hydroxyl groups are prone to losing electrons, exhibiting reducibility. Moreover, cyclic hydroxyl groups have a greater ability to lose electrons than chain hydroxyl groups. Therefore, it is easy to dissociate two protons. Most of the oxygen-containing functional groups in GO exist in the form of epoxy or hydroxyl groups. For epoxy groups, under the attack of ascorbic acid, one end forms a hydroxyl group and the other end is connected to the oxygen anion of ascorbic acid. At the same time, the other hydroxyl group on the double bond of the five membered ring of ascorbic acid undergoes a back attack to form a hydroxyl group that removes small molecules and forms an intermediate, while GO removes small molecules through elimination reactions, restoring the C-C conjugated system to rGO, and ascorbic acid is oxidized to dehydrogenated-ascorbic acid. Similar to the epoxy group, the hydroxyl group is replaced by the oxygen anion of ascorbic acid and undergoes a secondary attack on the backside, followed by elimination reaction and reduction. In ascorbic acid free radical scavenger-loaded reduced graphene oxide, the ring of ascorbic acid forms a n-conjugated structure with rGO, resulting in a significant increase in the electron loss ability of hydroxyl groups on the ascorbic acid chain compared to the pure ascorbic acid. Then, the ability to capture free radicals of ascorbic acid in ascorbic acid free radical scavenger-loaded reduced graphene oxide is enhanced. Therefore, the ascorbic acid free radical scavenger-loaded reduced graphene oxide is capable of annihilating macromolecular free radicals generated by NR macromolecules due to an action of heat and/or force during mixing and milling processes, an enhancement effect of the free radical annihilation reaction on an interfacial interaction between graphene and NR is stronger than hydrogen bonds.

The performance tests were performed on the NR composites obtained in Examples 1-3 and Comparative Example 1. The test standard for tensile performance was ISO 37-2005, with a tensile rate of 500 mm/min. The test standard for tear performance was GB/T 529-2008. With respect to the test for aging resistance, the rubber was aged at 100° C. for 1 d, with the tensile strength retention rate as the index. The test standard for hardness was GB/T 531.1-2008. The test standard for heat generation performance was GB/T 1687.1-2016. The test standard for abrasion performance was GB/T 9867-2008.

Table 1 showed the test results of tensile strength, tear strength, aging resistance, hardness, heat generation, and abrasion resistance of the NR composites obtained in Examples 1-3 and Comparative Example 1.

TABLE 1
Mechanical performances of NR composites obtained in
Examples 1-3 and Comparative Example 1

| | | | | Comparative |
|---|---|---|---|---|
| Sample | Example 1 | Example 2 | Example 3 | Example 1 |
| Tensile strength | 26.20 | 27.98 | 26.53 | 25.23 |
| (MPa) | | | | |
| Tear strength | 86.86 | 93.79 | 88.12 | 80.57 |
| (N/mm) | | | | |
| Aging resistance | 76.72 | 84.70 | 77.65 | 74.12 |
| (tensile strength | | | | |
| retention, %) | | | | |
| Hardness (HA) | 70 | 72 | 71.5 | 69 |
| Abrasion volume | 132 | 128.3 | 130.6 | 133.8 |
| (mm³) | | | | |
| Heat-generation | 23.53 | 21.23 | 22.2 | 23.73 |
| value (° C.) | | | | |

As shown in Table 1, the tensile strength, tear strength, aging resistance (assessed by tensile strength retention), heat generation under dynamic compression, and abrasion resistance of the graphene-modified NR obtained by the method of the present disclosure were significantly improved compared with the GO-modified NR composite of Comparative Example 1. In addition, the improvement of the tensile strength and tear strength of NR were achieved.

The embodiments described above are merely illustrative of the present application, and are intended to enable those skilled in the art to understand or implement the present disclosure, instead of limiting the scope of the present application. Although detailed descriptions have been made with reference to the above embodiments, modifications or equivalent substitutions to the technical solutions recited in the above embodiments made by those of ordinary skill in the art without departing from the spirit of the disclosure shall fall within the scope of the disclosure defined by the appended claims.

What is claimed is:

1. A method for preparing a graphene-modified natural rubber (NR) with an interfacial interaction based on a free radical annihilation reaction, comprising:
(1) dissolving a free radical scavenger in water to obtain a solution; and adding a graphene oxide aqueous dispersion with a preset concentration to the solution followed by reaction to obtain a free radical scavenger-loaded reduced graphene oxide (rGO) aqueous dispersion;
(2) adding deionized water to a natural rubber latex to obtain a latex emulsion, and mixing the free radical scavenger-loaded rGO aqueous dispersion with the latex emulsion under stirring to obtain a mixed emulsion, wherein rGO particles loaded with the free radical scavenger are bonded with rubber particles in the mixed emulsion to form bound particles under an action of an electrostatic attraction between rGO particles and negative ions from a protein-phospholipid membrane on a surface of the rubber particles;
adding a flocculant to the mixed emulsion to obtain a crude rubber, wherein flocculation occurs due to a reduction of repulsion between negative charges of the rubber particles in the mixed emulsion that keeps the mixed emulsion stable, and the rubber particles in the mixed emulsion whose protection layers are damaged and the rGO particles further undergo mutual adsorption by means of T-x interaction, such that the bound particles and the rubber particles in the mixed emulsion are orderly aggregated and co-precipitated from an aqueous phase to obtain the crude rubber; and
subjecting the crude rubber to water washing and drying to obtain a free radical scavenger-loaded rGO-modified NR masterbatch; and
(3) sequentially adding a rubber additive and a reinforcing filler to the free radical scavenger-loaded rGO-modified NR masterbatch during an mixing process in an internal mixer to obtain a rubber mixture; and cooling the rubber mixture to room temperature, and subjecting the rubber mixture to a milling process in an open two-roll mill, mixing with a vulcanizing agent and mill run until there are no bubbles in the rubber mixture; and allowing the rubber mixture to stand for a period of time, and placing the rubber mixture in a mold followed by vulcanization to obtain the graphene-modified NR composite; wherein the free radical scavenger loaded on the rGO particles are capable of annihilating macromolecular free radicals generated by NR macromolecules due to an action of heat and/or force during mixing and milling processes, an enhancement effect of the free radical annihilation reaction on an interfacial interaction between graphene and NR is obtained, thereby increasing a bound rubber content of natural rubber, increasing a crosslinking density of graphene-modified NR composite, and improving a crosslinking network of graphene-modified NR composite.

2. The method of claim 1, wherein in step (1), the free radical scavenger is selected from the group consisting of ascorbic acid, citric acid, sodium alginate, acrylic acid, sodium lignosulfonate, and a combination thereof; the reaction is performed at 60-120° C. for 2-6 h; and a mass ratio of the free radical scavenger to GO is 0.5-2:1.

3. The method of claim 1, wherein in step (2), the deionized water is added to the natural rubber latex such that a concentration of the latex emulsion is 10-40 wt. %; a concentration of the rGO particles in the free radical scavenger-loaded rGO aqueous dispersion is 0.5-5 mg/mL; and the flocculant is selected from the group consisting of a calcium chloride solution, a sodium chloride solution, a potassium chloride solution, a sodium sulfate solution, a hydrochloric acid solution, a formic acid solution, and a combination thereof.

4. The method of claim 1, wherein in step (3), a weight ratio of the free radical scavenger-loaded rGO-modified NR masterbatch to the reinforcing filler to the rubber additive is 100:30-90:10-20.

5. The method of claim 4, wherein in step (3), the rubber additive comprises an anti-aging agent, an antioxidant, an activator, a softener, and a vulcanization accelerator; and a weight ratio of the anti-aging agent to the antioxidant to the activator to the softener to the vulcanization accelerator to the vulcanizing agent is 2:2:5:2:2:2.

6. The method of claim 5, wherein the anti-aging agent is selected from the group consisting of 2,6-di-tert-butyl-4-methylphenol, 2,2,4-trimethyl-1,2-dihydroquinoline polymer, and 2-mercaptobenzimidazole;
the antioxidant is selected from the group consisting of N-(1-methylisopentyl)-N′-phenyl-p-phenylenediamine, p-phenylaniline, and dilauryl thiodipropionate;
the activator is selected from the group consisting of zinc gluconate, zinc oxide, and magnesium oxide;
the softener is selected from the group consisting of stearic acid, dibutyl titanate, and dioctyl adipate;
the reinforcing filler is selected from the group consisting of carbon black, silicon dioxide, and clay;
the vulcanization accelerator is selected from the group consisting of N-tert-butyl-2-benzothiazolesulfenamide, N-cyclohexyl-2-benzothiazolesulfenamide, and N-(oxydiethylene)-2-benzothiazole sulfenamide; and
the vulcanizing agent is sulfur or sulfur monochloride.

7. The method of claim 1, wherein in step (3), the mixing in the internal mixer is performed at 105-120° C. for 9-20 min; and the milling process in the open two-roll mill is performed at 50-70° C. for 8-12 min.

8. The method of claim 1, wherein in step (3), the rubber mixture is allowed to stand for 18-36 h; and the vulcanization is performed at 135-170° C. and 10-30 MPa for 3-25 min.
